(19) United States
(12) Patent Application Publication
(10) Pub. No.: US 2010/0324887 A1
(43) Pub. Date: Dec. 23, 2010

(54) SYSTEM AND METHOD OF ONLINE USER-CYCLED WEB PAGE VISION INSTANT MACHINE TRANSLATION

(76) Inventors: Mingchui DONG, Taipa (MO); Xiaolei Fei, Taipa (MO)

Correspondence Address: DONG Mingchui, Institute of Systems and Computer Engineering, Block 3, 1/F, University of Macau, Taipa, MO

(21) Appl. No.: 12/789,478

(22) Filed: May 28, 2010

(30) Foreign Application Priority Data
Jun. 17, 2009 (CN) 200910040304.X

(51) Int. Cl. G06F 17/20; G06F 17/00

(52) U.S. Cl. 704/8; 715/234

(57) ABSTRACT

This invention refers to a novel online user-cycled web page vision instant translation (OUWVIT) system and method, which is provided to capture, process and translate the online user-cycled paragraph of web page instantly. The system comprises Setting Module, Cycle and Screen-snapshot Module, Character Recognition Module, Bilingual Translation Module, Translation Result Display Module and Translation Database, wherein the said Setting Module is used to set specific shortcut key; the said Cycle and Screen-snapshot Module is used to capture the user-cycled paragraph of web page after user cycles the paragraph on web page; the said Character Recognition Module is used to recognize and process the text in the captured paragraph and eliminate the non-text information; the said Bilingual Translation Module translates the recognized and processed text to target language instantly; the said Translation Result Display Module displays the translation result in a pop-up independent window. It is noteworthy that the linkages and communications between modules are implemented automatically. The system and method can be applied to various types of wired or wireless Internet accessing equipments including personal computers, embedded or portable systems, system chips, cell phones and other mobile electronic devices. The core values of the present invention are that it is neither restricted by inner design framework format and programming language of web page, nor restricted by outer displaying style, animation and colors. It thoroughly overcomes the fatal shortcomings of existing online translation systems, which are significantly restricted by inner framework layout of web page. Consequently, it translates the user-cycled any paragraph of web page from source language to target language for reading instantly and freely.

### BACKGROUND OF THE INVENTION

The present invention refers to a novel online user-cycled web page vision instant translation (OUWVIT) system and method used to capture and translate the user mouse-cycled paragraph on web page, which might be mixed with colorful complicated images and graphs. The system and method can be applied to various types of wired or wireless Internet accessing equipments including personal computer equipments, embedded or portable systems, system chips, cell phones and other mobile electronic devices. The core values of such an invention are that it is neither restricted by inner design framework format and programming language of web page, nor restricted by outer displaying style, animation and colors. It thoroughly overcomes the fatal drawbacks of existing online translation systems, which are significantly restricted by inner layout of web page. Consequently, it translates the user cycled any paragraph of web page from source language to target language for reading instantly and freely. The technical field is categorized as web vision instant translation technology.

Nowadays Internet provides globally huge amount of information and accelerates greatly the exchange of information. People can access worldwide news and data easily and efficiently just through accessing Internet. However, while enjoying enormous convenience of accessing web information, people may encounter the language barrier because web pages on the Internet provided by different countries are normally displayed in their favorite few languages. It is definitely difficult for users to browse the web information written in their unfamiliar foreign languages. Therefore, the possible solution to solve such a challengeable problem is to translate instantly the web page from source language to target language while still keeping the format and animation of web page as original, which promotes the corresponding web vision instant translation technology.

Web vision instant translation is an innovated application adapted the technologies crossing the areas of machine translation, image processing, object character recognition as well as artificial intelligence, which should provide at least following 3 main functions:

1. Online translate the user interested content of web page instantly and precisely.

2. Concurrently display the original web page and translated result for easy reading.

3. It is activated only when user clicks an icon and calls such a system out to translate the interested web content without disturbing user's other computer operation.

So far, the methods of existing web translation service can be classified as following 3 types:

1. Translation is implemented through translation website. Through Internet, the customer sends the web address of desired web page to the server offering translation service and receives the translated results.

2. Translation is realized at client terminal. User installs browser software, which has online web translation function, in local computer. Through this browser user can access and translate the web content written in foreign languages.

3. Translation is implemented through e-mail translation service. Through e-mail user sends the copied web contents to the company that provides online translation service and receives translated results by e-mail.

Therein, the third method can not be regarded as the real instant machine translation while the other two can be classified as online remote translation and online local translation respectively. The drawbacks of online remote translation lie on the low communication speed affected by network bandwidth, unbalanced resources utilization, and lack of user's adequate control. Moreover, owing to the usage of online language corpora, the translation speed will greatly suffer from the unstable networking or poor communication quality when the client keeps on sending requests to the server during translation procedure.

The current progress of browser-oriented translation system mainly focuses on developing a proper machine translation algorithm, whose main difficulty relies on analyzing the inner HTML structure of web page. Mainly, a web page is constructed by text plus some HTML format tags. If the source file of that web page is directly decomposed into several parts according to the format tags, the integrity of original content of that web page might quite possibly be damaged or destroyed by this division, so that cannot translate correctly the whole meaning of web text. As a matter of fact, the decomposition should be done carefully so as to keep each sentence or paragraph as a whole for translation, even though some parts of sentence or paragraph might be divided and separated by format tags. In addition, it should be noted that the translated text is expected to be properly formatted by inserting format tags too. Hereby, the technical challenges are two: how to insert HTML format tags into the translated target text properly as well as how to translate the decomposed pure text. As to HTML file, it is of course cannot separate the format tags from the source text and then re-insert them to their original appeared places in translated target language, because the source and target languages normally have different structures and hardly to find one-to-one correspondence. Thus, in accordance with existing technologies the new method to solve this problem is addressed as follows: firs mark the HTML format tags and text individually, then translate the pure text and mark it respectively. By comparing the source and target languages the system will mark it same as source text if the structure of target language and source language coincide completely, otherwise will locate the corresponding part and add necessary marks if they do not coincide.

It is apparently that the above mentioned method is very cumbersome and inefficient due to the facts that the web development technology evolves quickly now, and new tags appear in the web page source code minutely. Moreover, the web page layout composed by existing format tags changes every moment, which requires web instant translation system updating its web page layout recognition module promptly and accordingly. All of these not only reduce the efficiency of translation, but also increase the difficulty in later system maintenance.

In summary, the said web translation methods have following two disadvantages: First, user can not select the interested content on web page to translate but has to translate the entire web page, which is time-consuming and inefficient. On the second hand, the quickly updating web technology results in the case that the system can not identify the layout of web page and fails to translate whole web page.

### BRIEF SUMMARY OF THE INVENTION

In view of aforementioned various shortcomings of existing technologies, the objective of present invention is to provide a novel online user-cycled web page vision instant translation (OUWVIT) system and method, which translate the user cycled paragraph on browsed web page instantly. Another objective of present invention is to propose a new method of screenshot-based online whole web page instant translation, which gets rid of all existing web translation systems' structure and style.

The importance of such a proposed system and method is that it overcomes successfully the drawbacks of existing web translation systems which strongly depend on recognizing and processing the web page layout. In other words, it can truly translate any browsed content of any web page in Internet.

The online user-cycled web page vision instant translation system can work independently without affecting any web browser's window or disturbing user to browse the web. It brings much convenience since it requires only the user to click and call out the system and the online translation will be done instantly. The said system comprises of following modules: the “Setting Module” that offers a specific option for user to set a shortcut key, when this shortcut key is triggered, it calls said translation system to execute the “Cycle and Screen-snapshot Module”; the “Cycle and Screen-snapshot Module” captures the content of user-cycled paragraph of web page as an image automatically for later processing by other modules; the “Character Recognition Module” recognizes the text contained in previously captured paragraph image; the “Bilingual Translation Module” translates the recognized text through translation engine; the “Translation Result Display Module” displays the relevant translation results in a pop-up independent window for browsing. This display process does not affect the original web browser window so that the original and translated texts might be shown contrastively.

The benefit of said online user-cycled web page vision instant translation system and method lies on that the instant translation of user-cycled web paragraph is realized through executing automatically a series of functions of Cycle and Screen-snapshot Module, Character Recognition Module, Bilingual Translation Module and Translation Result Display Module; moreover due to the system is independent of any web browser, its function will not be affected even user applies different web browsers in different operating systems as well as views differently formatted web pages developed by using different programming languages. Furthermore, the said system works totally independently and does not rely on any other software systems and network resources such as online dictionary or online translation website. Without typing any word or paragraph manually, by using mouse, user needs only to cycle the interested web paragraph and the system automatically translate it. The translated results appear in a pop-up independent window promptly that does not overlap or affect user's current browsing web page, thus user can see source and target languages contrastively, which can be saved or closed by user at any time.

The presented invention will be further elaborated through depicting the following drawings and the manner of practical implementation:

### BRIEF DESCRIPTION OF THE DRAWINGS

FIG. 1A is structure schematic of presented online user-cycled web page vision instant translation system;

FIG. 1B is appearance graph of translation interface of presented online user-cycled web page vision instant translation system;

FIG. 1C is schematics of a case applying the presented online user-cycled web page vision instant translation system;

FIG. 1D shows the paragraph captured by the presented online user-cycled web page vision instant translation system with the dashed rectangular box;

FIG. 1E is the view of translation result of user-cycled paragraph of web page translated by the presented online user-cycled web page vision instant translation system;

FIG. 2 is the control logic diagram of the presented online user-cycled web page vision instant translation system.

### DESCRIPTION OF THE LABELS MARKED IN FIGURES

10 Setting Module
11 Web page
12 Cycle and Screen-snapshot Module
13 Character Recognition Module
14 Bilingual Translation Database
15 Bilingual Translation Module
16 Translation Result Display Module
S20-S29: marks for different steps

### DETAILED DESCRIPTION OF THE INVENTION

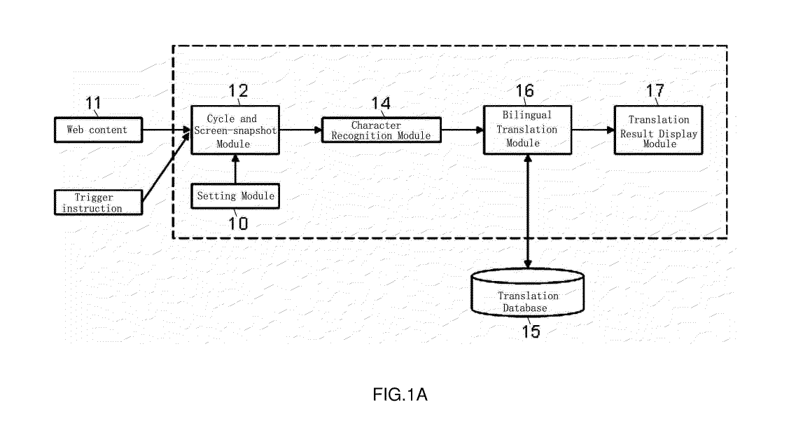

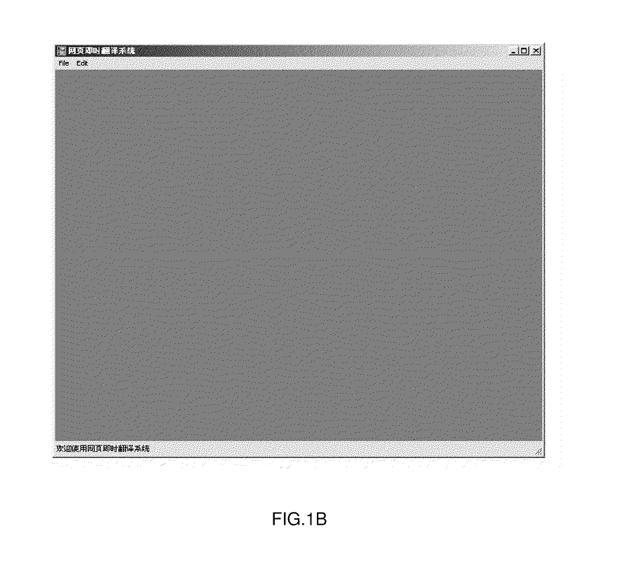

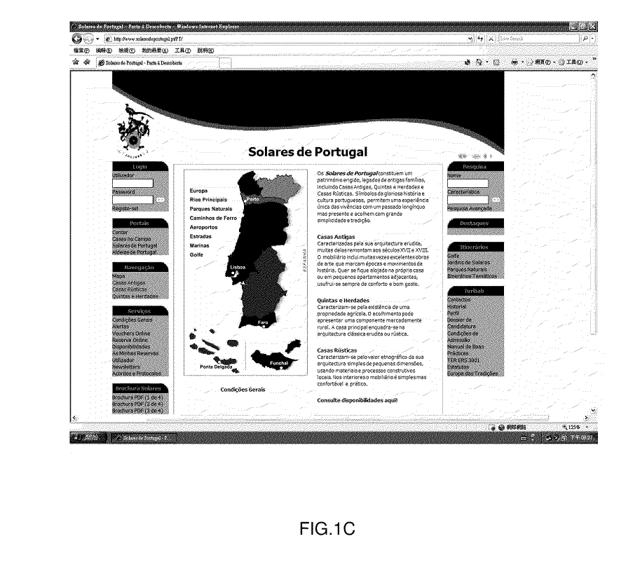

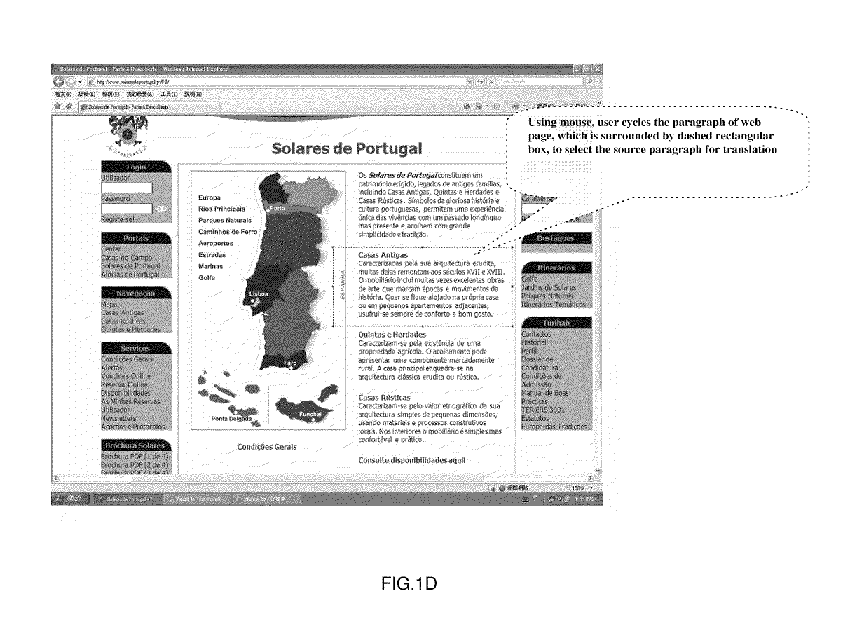

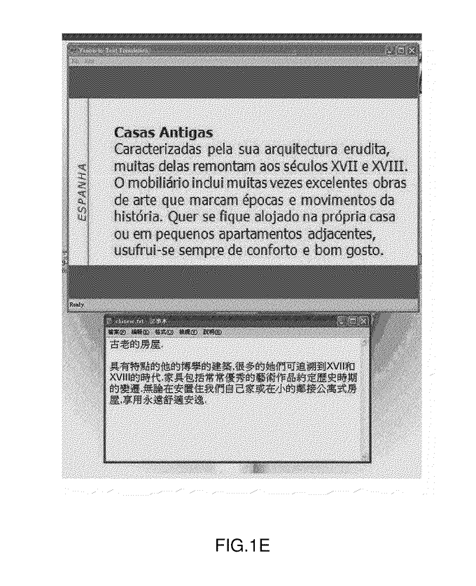

Referring to FIG. 1A, the online user-cycled web page vision instant translation system is applicable for various types of wired or wireless Internet accessing equipments including personal computer equipments, embedded or portable systems, system chips, cell phones or other mobile electronic devices. Such a system is provided to capture the user free cycled paragraph on web page and translate it instantly. The said system consists of following sequential linked and communicated modules:

The Setting Module 10 is used for user to set shortcut key, enabling user call out and fast operate the translation system;

The Cycle and Screen-snapshot Module 12 is used to capture the user-cycled paragraph automatically after user cycling the paragraph on the web page;

The Character Recognition Module 14 is used to recognize and process the text in captured paragraph and eliminate the non-text information;

The Bilingual Translation Module 16 is used to translate the recognized and pre-processed text instantly, such that to obtain the translated results expressed in target language;

Moreover there is Translation Database 15, which is linked and communicated to the Bilingual Translation Module 16.

The presented invention can be applied in any web browser running on any Internet accessing electronic device. As an example, in this section the application of such a system running in Internet Explore (IE) on desktop computer is described in details.

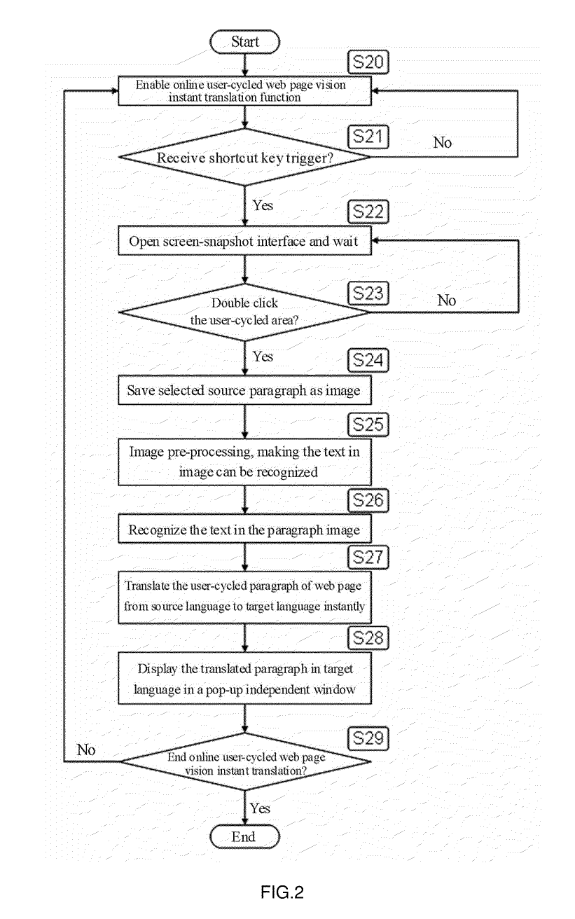

As shown in FIG. 1B, 1C, 1D, 1E and FIG. 2, the translation method applied the said online user-cycled web page vision instant translation system comprises the following steps:

S20: Start the system and set shortcut key through the Setting Module 10;

S21: Wait and check whether receiving any trigger instruction sent from clicking the user specified shortcut key;

S22: The Cycle and Screen-snapshot Module 12 opens screen-snapshot interface after receiving the trigger instruction sent from clicking the user specified shortcut key;

S23: On browsing web page, double click the user-cycled paragraph surrounded by dashed rectangular box so as to select the source paragraph for translation;

S24: Save the selected source paragraph as image;

S25: Adjust automatically the attributes of saved image, including gray scale, saturation and brightness; finally transform the source image to black and white binary format and save it automatically;

S26: Recognize the text from the source image through pattern recognition algorithm provided in Character Recognition Module 14, and save the result in a file;

S27: Send the file obtained in step S26 to the Bilingual Translation Module 16 and translate it instantly;

S28: Display the translation result obtained in step S27 in a pop-up independent window created by the Translation Result Display Module 17;

S29: Complete the online user-cycled web page vision instant translation in this time. System is waiting the next user-cycle operation.

FIG. 2 shows the flow chart of the presented online user-cycled web page vision instant machine translation method. This method refers to the online user-cycled web page vision instant translation method with all or part of above mentioned features, which can be implemented in various types of wired or wireless Internet accessing equipments including personal computer equipments, embedded or portable systems, system chips, cell phones or other mobile electronic devices. In next section, the said method will be elaborated by an example showing how user cycles paragraph of web page and gets the translation instantly based on PC IE browser. However, the presented invention is definitely not restricted to this usage.

First, perform step S20 to start the system; then go to step S21 automatically, wait and check whether receiving the trigger instruction sent from clicking user specified shortcut key, for instance defined as “F10”; if yes, perform step S22 automatically and enter the user Cycle and Screen-snapshot procedure; if not, return to step S21 and continuously wait and check.

In step S22, the current web page that user is browsing is still, and the cursor of mouse on the screen turns to a small cross cursor. At that moment, user could press left button of mouse anywhere on web page then drag and release so as to cycle the interested content of web page, forming a dashed rectangle determined by pressing and releasing cursor on the screen. The dashed rectangular box can be zoomed in or out, or dragged up/down, left/right. During and after dragging, user can right click the mouse to cancel the selection freely. After confirming that the paragraph covered by the dashed rectangular box is the content to be translated, double left-click the dashed rectangular box, confirm the selected paragraph and then go to step S23 automatically.

In step S23, wait and check whether receiving the double left-clicks on dashed rectangular box; if yes, go to step S24 automatically; if not, return to step S23.

In step S24, save the paragraph of web page covered by the dashed rectangular box as source image and then go to step S25 automatically. At this moment, end the Cycle and Screen-snapshot Module and enter the Character Recognition Module.

In step S25, adjust the attributes of saved source image, including gray scale, saturation and brightness, transform the source image into black and white binary format and save it automatically, then go to step S26.

In step S26, recognize the text in source image through using patter recognition algorithm, and save the result in a file so as to pass it to the Bilingual Translation Module to do instant translation. So far, end the Character Recognition Module and will enter Bilingual Translation Module, therefore go to step S27.

In step S27, call out the translation engine to translate the recognized text paragraph instantly and then go to step S28.

In step S28, display the translated result of user-cycled paragraph of web page in a pop-up independent window and then go to step S29.

In step S29, judge whether the operation flow ends or not, if receive exit message, end the operation flow; if not, return to step S21.

As a summary, the said online user-cycled web page vision instant translation system and method implement instant translation to the user-cycled paragraph of web page on browser window through executing automatically a series of functions of Cycle and Screen-snapshot Module, Character Recognition Module, Bilingual Translation Module and Translation Result Display Module; moreover due to the system is independent of any web browser, its function will not be affected even user applies different web browsers in different operating systems as well as views different formatted web pages developed by using different programming languages. Furthermore, the said system works totally independently and does not rely on any other software systems and network resources such as online dictionary or online translation website. Without typing any word or paragraph manually, by using mouse user needs only to cycle and confirm the interested web content and the system automatically translate it fast. The translated results appear in a pop-up independent window promptly that does not overlap or affect user's current browsed web page, thus user can see source and target languages contrastively, which can be saved or closed by user at any time.

It is noteworthy that the aforementioned technical implementation and operation is only an example for elaborating the principle and effect of the presented invention, which does not restrict the presented invention. The individual details of which can inspire different technical ideas and applications. Therefore, the various revisions, modifications and changes without deviating from the spirit and scope of the present invention should be included by the scope of protection of present invention.

We claim:

1. An online user-cycled web page vision instant translation system applicable for various types of wired or wireless Internet accessing equipments including personal computers, embedded or portable systems, system chips, cell phones or mobile electronic devices, which can capture and process the user free cycled paragraph of web page and translate it instantly; the said system consists of following sequential linked and communicated modules:
A Setting Module (10) offers a specific option for user to set shortcut key, when this shortcut key is triggered, it calls and executes said translation system promptly;
A Cycle and Screen-snapshot Module (12) captures the user-cycled paragraph of web page automatically after user cycles the interested content on web page;
A Character Recognition Module (14) recognizes and processes the text contained in the captured paragraph and eliminate the non-text information;
A Bilingual Translation Module (16) translates the recognized and processed text instantly, such that to obtain the translated results expressed in target language;
A Translation Result Display Module (17) displays the relevant translation results in a pop-up independent window for browsing without affecting the original web browser window so as to show the original and translated text contrastively.

2. The system as in claim 1 further includes a Translation Database (15), which is linked and communicated to the Bilingual Translation Module (16).

3. The online user-cycled web page vision instant translation method adapted in the system of claim 2 comprises the following 10 steps:
S20: Start the system and set shortcut key through Setting Module 10;
S21: Wait and check whether receiving any trigger instruction sent from clicking the user specified shortcut key;
S22: The Cycle and Screen-snapshot Module 12 opens screen-snapshot interface after receiving the trigger instruction sent from clicking the user specified shortcut key;
S23: On browsing web page double click the user-cycled paragraph surrounded by dashed rectangular box to select the source paragraph for translation;
S24: Save the selected source paragraph as image;
S25: Adjust the attributes of saved image, including gray scale, saturation and brightness automatically; transform the source image to black and white binary format and save it finally;
S26: Recognize the text from the source image through pattern recognition algorithm provided in Character Recognition Module 14, and save the result in a file;
S27: Send the file obtained in step S26 to the Bilingual Translation Module 16 and translate it instantly;
S28: Display the translation result obtained in step S27 in a pop-up independent window created by the Translation Result Display Module 17;
S29: Complete the online user-cycled web page vision instant translation in this time; system is waiting the next user-cycle operation.
